(19) United States
(12) Patent Application Publication
(10) Pub. No.: US 2018/0370173 A1
(43) Pub. Date: Dec. 27, 2018

(54) FLEXIBLE CONTAINERS COMPRISING A LOWER BASE OF ESSENTIALLY RECTANGULAR CONFIGURATION, METHOD, MODULE AND MACHINE FOR THEIR MANUFACTURE

(71) Applicant: PFM IBERICA PACKAGING MACHINERY, S.A., SANT JOAN DESPI (ES)

(72) Inventors: Jose GARRIGA JIMENEZ, Les Franqueses Del Valles (ES); Andrea FIORAVANTI, Schio (IT); Cristobal JORGE ALESANCO, Barcelona (ES)

(73) Assignee: PFM IBERICA PACKAGING MACHINERY, S.A., SANT JOAN DESPI (ES)

(21) Appl. No.: 15/747,345

(22) PCT Filed: Jul. 15, 2016
(86) PCT No.: PCT/ES2016/070536

§ 371 Date: Jan. 24, 2018

(30) Foreign Application Priority Data
Jul. 24, 2015 (ES) P 201531100

(51) Int. Cl. B31B 70/26

(52) U.S. Cl. CPC B31B 70/261; B31B 70/008

(57) ABSTRACT

A method for the manufacture of flexible containers of the type comprising a lower base and four side faces comprising supplying a W-shaped folded web determining an inverted “V” shaped bottom, with a central fold being distinguished, and the steps of inserting folded sheets between the opposite walls of the W-shaped web so that, at least, one bonding portion of each folded sheet is attached to the opposite walls and to the bottom of the web in the shape of an inverted “V”, and to bond these folded sheets to the web at said bonding portion or portions to determine dividing walls on the web prior to performing transverse cuts on the web to individualise a container, the cuts being distanced so that each container includes, at least, two of said dividing walls that will form respective side walls on each container.

### TECHNICAL FIELD OF THE INVENTION

The invention relates to a method for manufacturing flexible containers comprising a lower base of essentially rectangular configuration from which four side faces of the package, bonded together at their corners, rise. The invention also relates to a module for implementing the method and a machine incorporating said module.

### BACKGROUND OF THE INVENTION

Containers are already known, which are made from flexible material adopting, when full, a form in which a flat, essentially rectangular base is distinguished, from which four side faces of the package, bonded at their corners, rise, two of which being juxtaposed on the top of the container closing its upper part. Such packages are sometimes identified in the trade under the name of “quad-seal” or “flat-bottom stand-up”.

Generally, to obtain said containers industrially, the use of various sheets of material forming the container, which will be suitably manipulated and bonded together for the formation of the container, is necessary. Such is the case, for example, of the ways of obtaining containers described in patent documents US 2012231941 and WO 201540631, in which different sheets are used to form each of the four side walls of a container and another added sheet to form the base of the container.

An alternative to this procedure is described in EP 15411332, in which the same sheet forming a first larger side face of the container also forms the lower base thereof. However, this approach requires having to manipulate, in the middle of the container's formation, a critical area thereof. In particular, it is necessary to have to flatten the base of the container, once placed false sheets, which will form two smaller side faces of the container, in order to be able to bond to the base and to these false sheets another sheet that will form the second larger side wall of the container.

One of the objects of the invention is a method of production that allows obtaining containers with a smaller number of sheets.

Moreover, the complexity of the machines used, to date, for the preparation of these packages is significantly higher than the machine which makes other also well-known containers, with only two side faces and consequently of various benefits, such as the “doy-pack” or “stand-up pouch” type containers, since the machines used are able to continually make containers from a single continuous film of flexible material that is drawn from a film storage reel, or of various films of flexible material drawn from respective film storage reels and which are bonded together along each longitudinal seam to form a single film, which, conveniently folded over itself and by bonding operations of certain parts of it, allows the formation of successive pockets open at their upper parts that are individualised by transverse cutting the film thereby obtaining open containers. Conventionally, these machines integrate modules for the filling and closure of the containers. Examples of machines for the manufacture of this type of “doy-pack” containers and various versions thereof are disclosed in the U.S. Pat. No. 5,845,463; U.S. Pat. No. 4,216,639 and GB 2351035.

The increased complexity of machines capable of forming containers of “quad-seal” type makes the resulting container expensive, and that the use of said containers is only economically viable when the product the containers contain offers a generous profit margin to the packager.

Therefore, largely due to the high cost and complexity of machines able to make “quad-seal” type containers, this part of the packaging process is often outsourced, so that there are first companies for the manufacture of containers and second companies, which, from pre-made containers, perform their filling and closing. This means that the packager has little control over the formation or manufacture of the containers and immediate changes in type of package are impossible, unless the packager has in stock pre-made containers of different types. As is known, stock incurs costs in storage and supply of the products in stock.

It is also, therefore, an object of the present invention, a particularly suitable method and device to integrate the manufacturing phase of “quad-seal” type packaging with the subsequent packaging phase, for example in the same production line or in the same machine.

It is also an object of the invention to provide a versatile method that allows making changes in the type of containers in a simple manner.

Also another object of the invention is an alternative machine to known machines for making packages such as the “quad-seal” type, and of a module, which can manufacture “quad-seal” type containers in combination with technical solutions already known in the sector, in order to make possible adapting machines or known production processes for implementing the method according to the invention.

### DESCRIPTION OF THE INVENTION

The proposed method is suitable for the manufacture of flexible containers of the type comprising a lower base essentially in parallelogram configuration, such as, for example, square or rectangular, and four side faces, the method comprising the usual step in the manufacture of such “doy-pack” packages of supplying a continuous web folded upon itself around longitudinal fold lines forming a W-shaped pleated area, which determines an inverted “V” shaped bottom, a central fold being distinguished, which is arranged between two opposite walls of the web; and the added steps of inserting folded sheets into the web between its opposite walls so that at least a bonding portion of each folded sheet is attached to the opposite walls and to the inverted “V” shaped bottom of the web, and bonding these folded sheets to the web at said bonding portion or portions to determine dividing walls on the web prior to performing transverse cuts on the web to individualise a container, the cuts being distanced so that each container includes, at least, two of said dividing walls that will form respective side walls on each container.

Advantageously, the method according to the invention shares operations that are already common for the manufacture of another type of containers in the industry, even if dealing with different containers as are the “doy-pack” type containers.

This allows that a single machine may be prepared to manufacture containers of two different types, that is the “doy-pack” type container or the “quad-seal” type container. Logically, a machine with this capability offers very interesting advantages to packagers, who will be able to obtain line production of “quad-seal” type containers, whereas now they have to work with pre-made packaging.

In a variant of the method, the extension of the folded sheets is suitable for making each one two side faces of two containers to be manufactured consecutively, each folded sheet comprising two bonding portions, whose bonds with the opposite walls and with the bottom determine a double dividing wall on the web, and the method comprises performing transverse cuts on the web between the bonding portions of the same folded sheet, so that on each side of the transverse cuts a dividing wall will form one side wall of two consecutive containers.

According to one embodiment, the method comprises the operations of providing sheets of suitable extension to make each one two side faces of two containers to be manufactured consecutively, each sheet having a central area of a series of fold lines as a rhombic figure, engraved on the sheet in such a way that two opposite vertices end up on respective edges of the sheet; and of a straight fold line with a central sector extending between the other two vertices of the rhombic figure and two end sectors extending each one from the central sector to a corresponding end of the sheet; folding the sheet in a direction around the end sectors of the straight fold line and folding the sheet in an opposite direction around the central section of said straight fold line allowing that the sheet also folds itself around the sides of the rhombic figure to obtain a folded sheet, which determines a flattened formation, wherein a sort of triangular peak, able to fold down or fold out around the central sector of the straight fold line, is distinguished, and two side wings, which each determine a dividing wall on the web; arranging the thus folded sheet between the opposite walls of the web in such a way that the central sector of the straight fold line meets the central fold of the inverted “V” shaped bottom formed on the web, the edges of the folded sheet and its straight imaginary extensions through the interior part of the peak determining respective bonding portions of the folded sheet, which remain attached to the opposite walls and the bottom of the web; and bonding the web and the folded sheet on said bonding portions to form the double dividing wall on the web.

The invention provides that, prior to bonding the web and the folded sheet on said bonding portions to form the double dividing wall on the web, a preliminary operation of bonding the sheet to the web is performed, consisting of bonding small areas of each side wing to each one of the two opposite walls of the web.

As for the sheets, these can be cut from a continuous auxiliary web drawn from another web storage reel, and the marking of fold lines according to the rhombic figure and to the straight fold line can be made on them, prior to or after being cut from the auxiliary web.

In a variant, the method comprises performing longitudinal bonding seams on the web, coinciding with the folding lines, which limit the “V” shaped bottom with each of the opposite walls of the web once the folded sheets are inserted into the web.

In a variant, the folded sheets or the sheets from which the folded form is obtained, have at each bonding portion, or adjacent thereto, pairs of slits or perforations, which overlie when the folded sheet is inserted into the web, the method comprising the operation of bonding together the opposite walls of the web or the side walls of a container through said slits or perforations.

Note that the operations, which are performed after introducing the folded sheets between the opposite walls of the web in the manufacture of “quad-seal” type packages may be consistent with those performed in the manufacture of “doy-pack” type packages. This allows, as discussed below, that, at least, the operations of filling and closing the packages can be performed in a package filling and closing module located downstream from the transverse cuts operation of the web and that these means do not have to be altered depending on whether the manufactured containers are of one type or another. Moreover, even the means used to perform transverse seals on the web and to form seams on the base of the containers may be consistent to both packages. Therefore, there is the possibility of making the “quad-seal” type containers and filling and closing them in the same machine, which is also able to make “doy-pack” type containers, using the same means for sealing, cutting, filling and closing of the containers.

That is why, according to another aspect of the invention, a method is disclosed for manufacturing flexible containers of the type comprising a lower base and at least two opposite side faces, comprising the operation of supplying a continuous web folded upon itself around longitudinal fold lines forming a W-shaped pleated area, which determines an inverted “V” shaped bottom, a central fold being distinguished, which is arranged between two opposite walls of the web, intended to form respective first and second opposite side faces of a container, the method being characterised in that it comprises selecting the type of container to be manufactured from at least two types
a first type, in which the side faces of the container are bonded together by determining two side seams in the finished container, for which the method comprises the step of performing transverse seals on the web to bond the opposite walls of the web together prior to cutting the web transversely to individualise a container; or
a second type, in which, between the side faces of the container, on each side of the container, a third and a fourth side face are interposed, providing the container with the ability to take, on standing, an essentially quadrangular or square shape, for which the method comprises the step of inserting and bonding folded sheets on the web between its opposite walls to determine dividing walls on the web prior to performing transverse cuts on the web to individualise a container, the cuts being distanced so that each container includes at least two of such dividing walls that will form respective side walls on each container.

According to another aspect of the invention, a module for implementation of the method is presented, said module comprising means prepared for supplying previously manipulated sheets for their marking with preferential folding lines; folding means and introducing means, which act in a coordinated manner to shape the sheet by folding it around the preferential folding lines and to accompany the folded sheet to arrange it within the web and so that, at least, one bonding portion on the folded sheet is attached to the opposite faces and the inverted “V” shaped bottom of the web; and means of obtaining the bonding of these sheets to the web on said bonding portions to determine dividing walls on the web.

According to a variant, the folding means and introducing means comprise a pusher, movable toward the web in a direction essentially normal to the extension thereof; and an introducing template, generally funnel-shaped and intended to be traversed by the assembly formed by the pusher and the folded sheet that accompanies said pusher in its trajectory towards the web.

In a preferred embodiment, the folding means and introducing means comprise a series of ridges formed on the pusher acting on the sheet during its pushing in combination with the passage section offered by the introducing template, whose profile determines the gauge of the folded sheet on its passage through the introducing template.

Preferably, the module comprises stop means for receiving the slidable support of the bottom of the web and prepared to act as end of stroke of the folded sheet with interposition of the bottom of said web.

It is contemplated that the stop means are heated.

In a variant, the module comprises means for pre-welding, prepared for provisionally bonding and in small areas, the sheets to each of the opposite walls of the web.

A machine for manufacturing flexible containers of the type comprising a lower base in essentially parallelogram configuration and four side faces, which may comprise means for supplying a continuous web folded upon itself around longitudinal fold lines forming a W-shaped pleated area, which determines an inverted “V” shaped bottom, a central fold being distinguished, which is arranged between two opposite walls of the web; and a module according to the invention.

Among the obtainable containers with the method, according to the invention, is of interest a flexible container comprising a lower base in essentially parallelogram configuration, from which, four side faces rise, the lower base and two of its noncontiguous side faces being integrally formed by the same sheet; and the two remaining side faces by respective auxiliary sheets; wherein said remaining side faces are in a top part of the container folded towards the interior thereof, the container being able to take on in said top part a flat shape by juxtaposing the side faces; and, in which integral parts of the container in this top part have been made to prevent the unfolding of said side faces in the form of bonds between parts of the sheet through the remaining side faces; and/or bonds of each one of the remaining side faces to the sheet on one of the side faces.

### BRIEF DESCRIPTION OF THE DRAWINGS

FIG. 1 is a schematic view of the method according to one variant of the invention;

FIG. 2 is a view of a module for introducing a folded sheet between the opposite walls of the web, from which two side faces and the base of a container will be formed;

FIG. 3 is a schematic view of the operation of introducing the folded sheet between the opposite walls of the web;

FIG. 4 is a sectional view along a normal cutting plane of the web showing the moment that the folded sheet is arranged between the opposite walls of the web so that the folded sheet meets the centre fold of the inverted “V” shaped bottom;

FIGS. 5, 6 and 7 are a sequence of obtaining the folded sheet from a sheet marked with the preferred fold lines;

FIG. 8a shows the folded sheet, with two bonding portions for bonding the opposite walls of the web to form a double dividing wall having been indicated;

FIG. 8b shows the folded sheet of FIG. 8a, as a bottom view, with its peak portion completely open to illustrate the bonding portions with the bottom of the web in this part of the folded sheet;

FIGS. 9 and 10 show respective schematic views in perspective and plan view, respectively, of the operations performed after the folded sheets are inserted between the walls of the web;

FIG. 11 is another schematic view and according to an alternative to the method of FIG. 10 of the operations performed after the folded sheets are inserted between the walls of the web;

FIGS. 12 and 13 show an empty, finished container and when it takes on a filled form, respectively, obtainable with the method of the invention;

FIGS. 14 and 15 show another empty, finished container and when it takes on a filled form, respectively, obtainable with the method of the invention;

FIG. 16a shows schematically and in section the package of FIGS. 14 and 15; and

FIG. 16b shows in greater detail but schematically the same container in an open form, along the cutting plane AA of FIG. 16a.

### DESCRIPTION OF A PREFERRED EMBODIMENT OF THE INVENTION

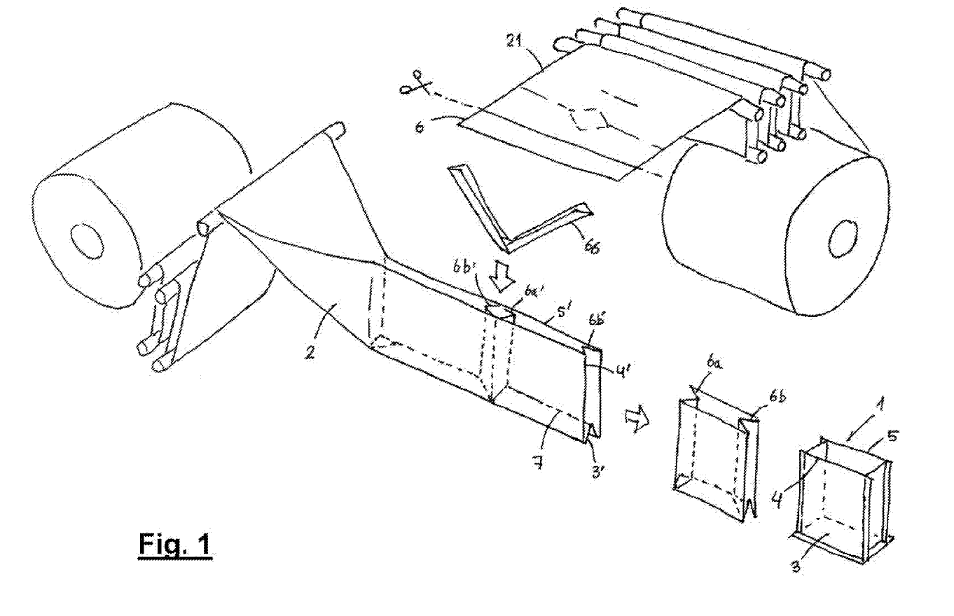

FIG. 1 schematically shows the main operations of a method for manufacturing flexible containers 1 of the type comprising a lower base 3 of essentially rectangular shape and four side faces 4, 5, 6a, 6b, using in the example only one main web 2 and an auxiliary web 21.

In the method of FIG. 1, it comprises the operation of supplying the web 2 from a web storage reel and of folding it upon itself around longitudinal fold lines forming a W shaped pleated area that determines an inverted “V” shaped bottom 3′, a central fold 7 being distinguished, which remains arranged between two opposite walls 4′, 5′ of the web 2.

While in this example this formation in W is obtained by folding an initial single web 2, it is understood that the formation in W can be obtained from bonding together along longitudinal seams various starting webs. That is, in the context of the invention, the web, which is folded to obtain the form in W, may be formed by a single film or by several films bonded together.

As illustrated in FIG. 1, having been obtained the formation in W, the method comprises the added steps of inserting folded sheets 66 into the web 2 between its opposite walls 4′, 5′ and obtaining the bond of these folded sheets 66 to the web 2 to determine pairs of dividing walls 6a′, 6b′ on the web 2, prior to performing transverse cuts on the web 2 to individualise a container 1, the cuts being distanced so that each container 1 includes, at least, two of said dividing walls 6a′, 6b′, which will form the two side walls 6a, 6b in each container 1.

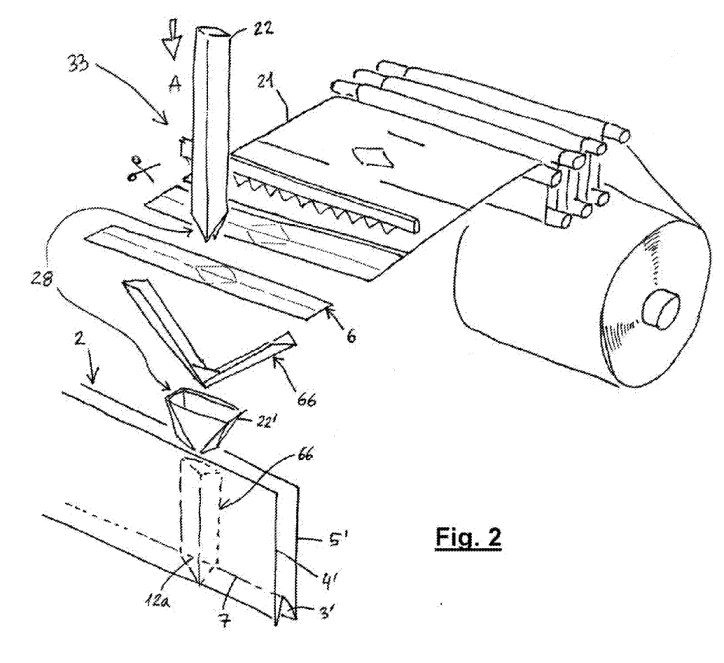

FIGS. 2 to 4 shows a module 33, which provides the preparation of these folded sheets 66, their introduction into the web 2 and their preliminary bonding on the web 2.

Specifically, this module 33 comprises means for folding and introducing means 28 that act in a coordinated manner to shape sheets 6 by folding them around preferential fold lines, and to move the already folded sheets 66 to arrange them inside the web 2.

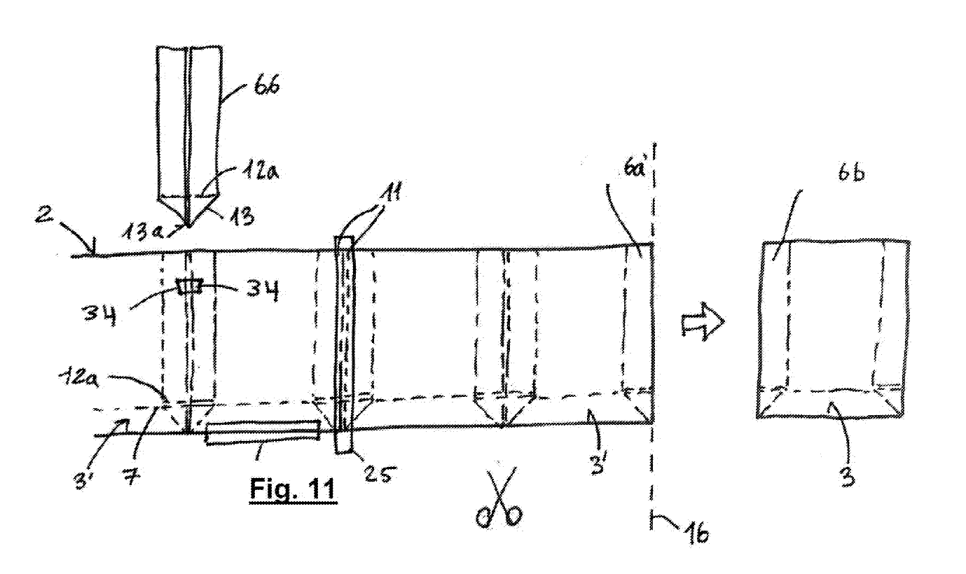

In the example of FIG. 2, the folding means and introducing means 28 comprise a pusher 22 movable in a direction essentially normal to the extension of the web 2 between two positions: a waiting position A (shown in FIG. 2) and an operative position B (shown in FIGS. 4 and 10).

The folding means and introducing means 28 further comprise an introducing template 22′, fixed in the example, generally funnel-shaped and adapted to be traversed by the pusher 22 in its run towards the web 2.

The module 33 also comprises means for supplying sheets 6 of adequate extension, in this case to form two sides of a finished container, manipulated to mark on them preferred fold lines, and to arrange them between the pusher 22 and the introducing template 22′ when the pusher takes on the waiting position A.

A series of ridges 31 are machined or formed on the pusher 22 acting on the sheet 6 when the pusher is driven in the direction of the web 2 in such a way that they fold the sheet 6 along the cited preferential folding lines while they displace the sheet towards the web 2. These ridges 31 act in combination with the passage section offered by the introducing template 22′, whose profile determines the gauge of the pre-folded sheet 66 as it passes through said introducing template 22′, all as shown in FIG. 2.

Although in the example, the module 33 comprises means for drawing a continuous auxiliary web 21 from a corresponding storage reel; for transversely cutting the auxiliary web 21 to obtain the sheets 6; and to mark the sheets 6 in the preferred fold lines, the invention also contemplates that the module 33 will be supplied sheets 6, dispensed from a sheet 6 storage reel. In this case, it is contemplated either that the sheets 6 stored are already marked or that the module 33 is provided with the necessary means to mark the sheets 6 before supplying them for introduction on the web 2.

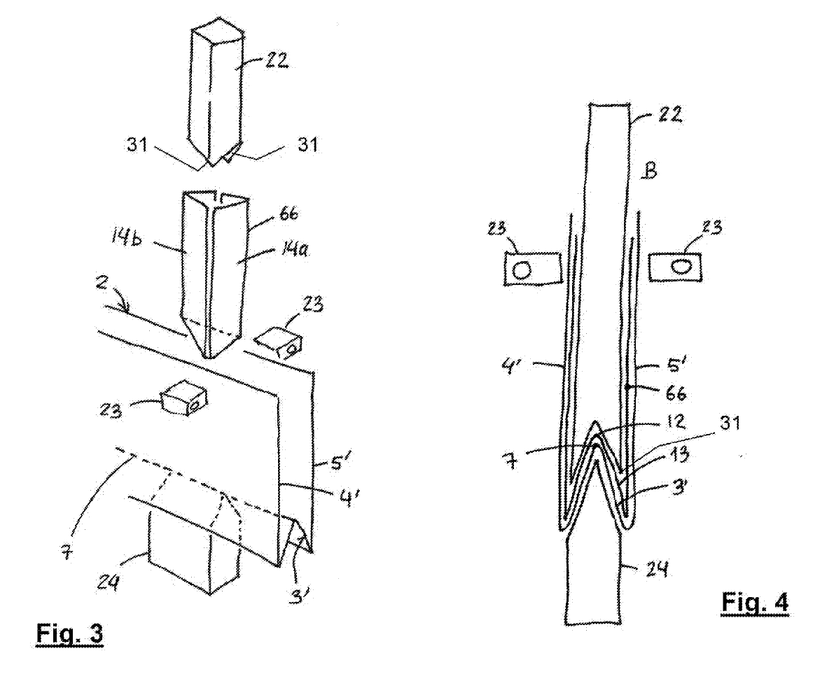

In either case, the module 33 is complemented by stop means 24, visible in FIGS. 3 and 4, for receiving the slidable support of the bottom 3′ of the web 2 and ready to act as end of stroke for the folded sheet 66, with interposition of the bottom 3′ of the web 2 during the insertion operation of the folded sheet 66 on the web 2.

These stop means 24 contribute to the folded sheet 66 being perfectly positioned on the centre fold 7 of the web 2, which is of interest to perfect the manufacture of the packages 1.

This operation is illustrated in greater detail in FIGS. 3 and 4, which show how the module 33 is further provided with pre-welding means 23, prepared for provisionally bonding and in small areas the sheets 66 to each of the opposite walls 4′, 5′ of the web 2, once said sheets are perfectly positioned on the central fold 7 of the web 2. In FIG. 4, to facilitate the understanding of this operation, the pusher 22 has been shown out of the folded sheet 66 when in fact the folded sheet 66 envelops the outside of said pusher 22 during its movement in the direction of web 2, as is properly illustrated in FIG. 4.

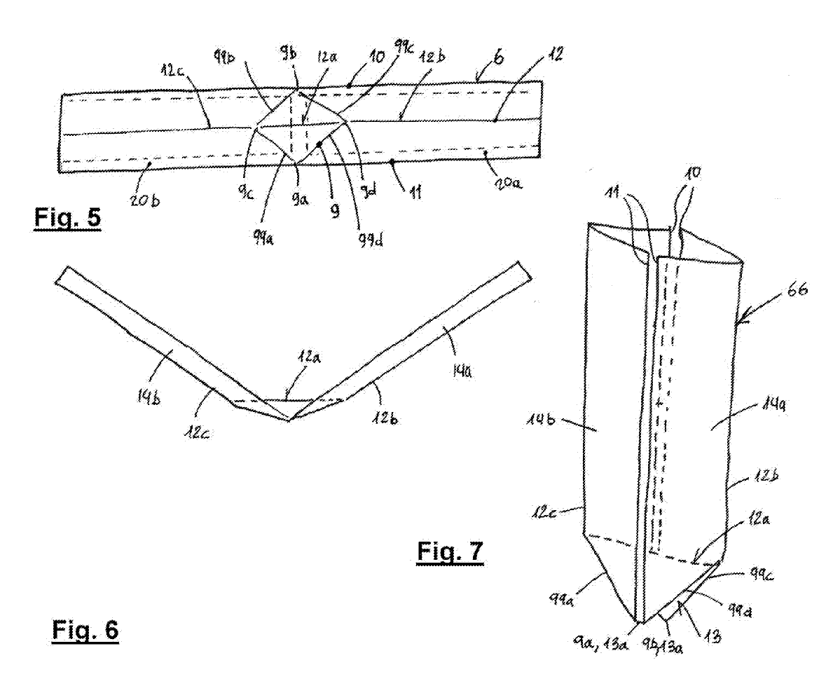

FIGS. 5 to 7 show in detail a method of operation of particular interest for obtaining the folded sheet 66 from a sheet 6.

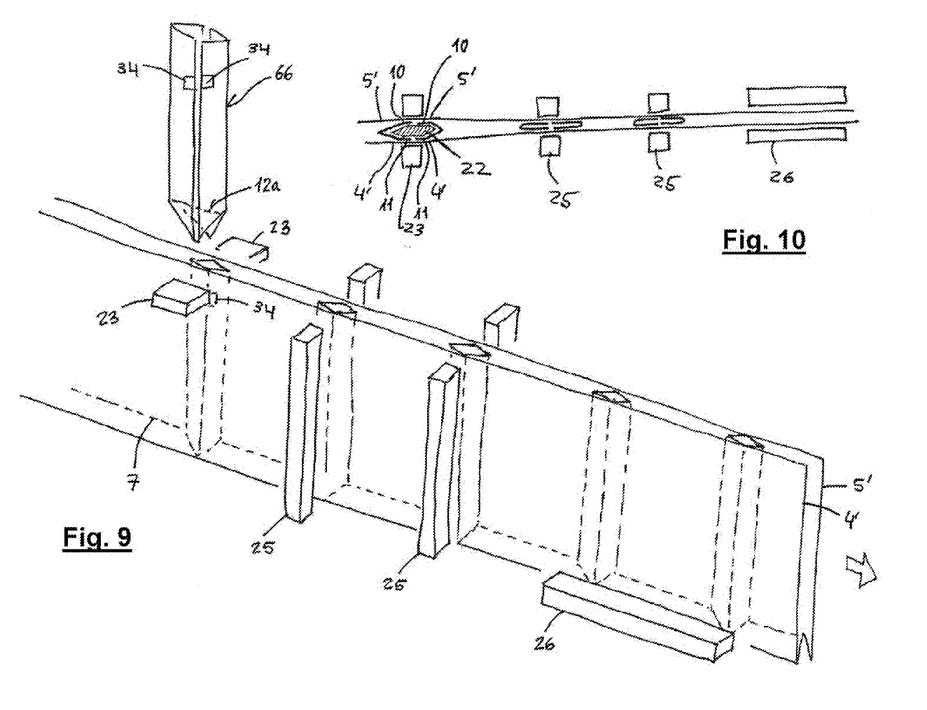

According to this method of operation, as shown in FIG. 5, it starts with an oblong sheet 6 of sufficient extension to form two side walls in the containers to be made. This sheet 6, in its central area, has a series of fold lines 9 forming a rhombic figure engraved on the sheet 6, so that the two opposite vertices 9a, 9b end in respective edges 10, 11 of the sheet 6; and a straight fold line 12 with a central sector 12a extending between the other two vertices 9c, 9d of the rhombic FIG. 9 and two end sectors 12b, 12c, each extending from the central sector 12a to a corresponding end of the sheet 6. As explained below, the fact that this central sector 12a is completely continuous, without interruption, contributes significantly to minimise undesirable defects in the making of the packages 1.

FIGS. 6 and 7 are a sequence of the folding of the sheet 6. Specifically, the sheet 6 is folded in one direction around the end sectors 12c, 12b of the straight fold line 12 and in an opposite direction around the central sector 12a of said straight fold line allowing the sheet 6 to also fold around the sides 99a; 99b; 99c; 99d of the rhombic FIG. 9 to obtain the folded sheet 66 with the flattened form as illustrated in FIG. 7. From this folded form the central sector 12a stands out, extending without interruption along the entire width of the folded sheet 66 and, consequently, allowing the correct positioning of the folded sheet 66 on the central fold 7 of the web 2.

In the flattened formation of said FIG. 7 a sort of triangular peak 13 is distinguished, folding down precisely around the central sector 12a of the straight fold line 12 and two side wings 14a, 14b which each determine a dividing wall 6a′, 6b′ (see FIG. 1) on the web 2.

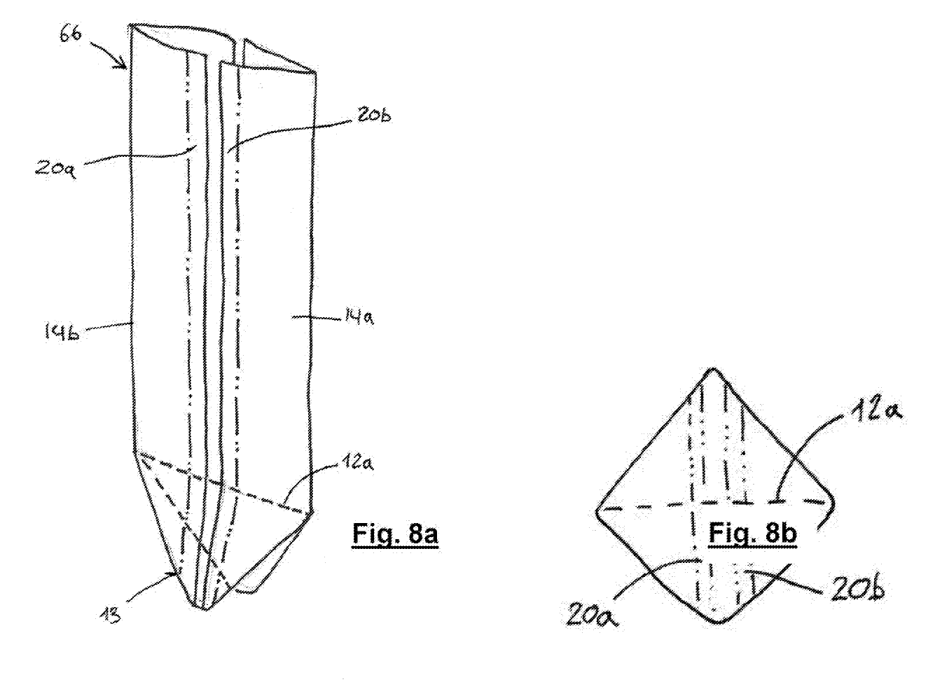

It is of interest to note that the inner surface of the peak 13, shown unfolded in FIG. 8a, intended to be juxtaposed to the bottom 3 of the web 2, is in fact a surface without interruption, determined by the rhombic FIG. 9 on the starting sheet 6.

These side wings 14a, 14b remain perfectly parallel and vertical, that is, normal to the central fold 7 and consequently the future base of the made container, through seamless support offered by the central sector 12a, favouring the correct making of said container.

FIG. 8 shows bonding portions 20a, 20b definable on the folded sheet 66 that will be attached to the opposite walls 4′, 5′ and to the bottom 3′ of the web 2 when the folded sheet is arranged between the opposite walls 4′, 5′ thereof and the central sector 12a meets the central fold 7 of the web 2. With the folded sheet 66 conveniently placed in this position, without removing the pusher 22, as illustrated in FIGS. 4 and 10, a preliminary bonding operation of the sheet 66 to the web 2 consisting of bonding small areas 34 is performed, (see FIGS. 9 and 11) of each side wing 14a, 14b to each of the two opposite walls 4′, 5′ of the web 2, using the pre-welding means 23 prior to drawing the web 2 and proceeding to a downstream work station to bond the web 2 and the folded sheet 66 along the bonding portions 20a, 20b to form the double dividing wall 6a′, 6b′ on the web 2.

In a way known per se, the pre-welding means 23 may consist of welding bars which provide heat to the material, of which the web 2 and the folded sheet 66 are made, for their bonding by heat welding. It is noted that the pusher 22 provides the necessary support so that the web 2 and the folded sheet 66 portion attached do not sink inward when the welding bars exert pressure from the exterior face of the opposite walls 4′ and 5′ of the web 2 during the operation of preliminary bonding between the web 2 and the folded sheet 66.

Downstream of this preliminary bonding operation, the method, which is illustrated by way of example, comprises the operations of performing transverse seals in the assembly formed by the web 2 and the sheets 66 in coincidence with the bonding portions 20a and 20b, for example by the set of welding bars 25; and making seams on the bottom 3′ of the web 2 between the transverse seals and on each of the longitudinal folds of transition between said bottom 3′ and each of the opposite walls 4′ and 5′, for example, by the set of welding bars 26. The welding bars 25 and 26 may be of the type which provide heat for bonding by thermal welding the inner faces of the web 2, which are mutually attached, which occurs in the area of the transition folds between the bottom 3 and the opposite walls 4′ and 5′ of the web 2, in which there is no interference with the folded sheets 66, and also the contact areas between the folded sheet 66 and the web 2 in the bonding portions 20a and 20b.

In order that the temperature be suitable in the areas more separated from the welding bars 25 and 26, that is, in the innermost points of the package formed by the web 2 and the folded sheet 66, for example in the area of the bonding portions 20a and 20b corresponding to the peak 13 attached to the bottom 3′ of the web 2 in the vicinity of the central sector 12a, it is contemplated that the stop means 24 are heated, to assist that the thermal swing between the welding bars 25 and/or 26 and these internal points of the package be lower and require less time to perform a proper bond by thermal welding.

Subsequently, the transverse cuts 16 are performed (see FIG. 11) to individualise made containers. In the example, the cuts 16 are made to coincide with each folded sheet 66 and particularly between each pair of dividing walls 6a′, 6b′ formed by the bond of each folded sheet 66 with the web 2.

In other provided variants, it is possible to distance the transverse cuts 16 so that the cut is performed every two or more folded sheets 66, so that each container 1 includes a folded sheet 66 in the middle, which can act as an intermediate partition, which provides the container the space to store, in this case, two separate products and/or products of a different nature.

In a variant of the method illustrated in FIG. 11, downstream of the preliminary bonding operation, the method comprises first performing bonding seams on the bottom 3′ of the web 2 between each two folded sheets 66 and each of the longitudinal folds of transition between said bottom 3′ and each one of the opposite walls 4′ and 5′, by welding bars 26; subsequently making transverse seals on the assembly formed by the web 2 and the sheets 66 in coincidence with the bonding portions 20a and 20b, by the set of welding bars 25.

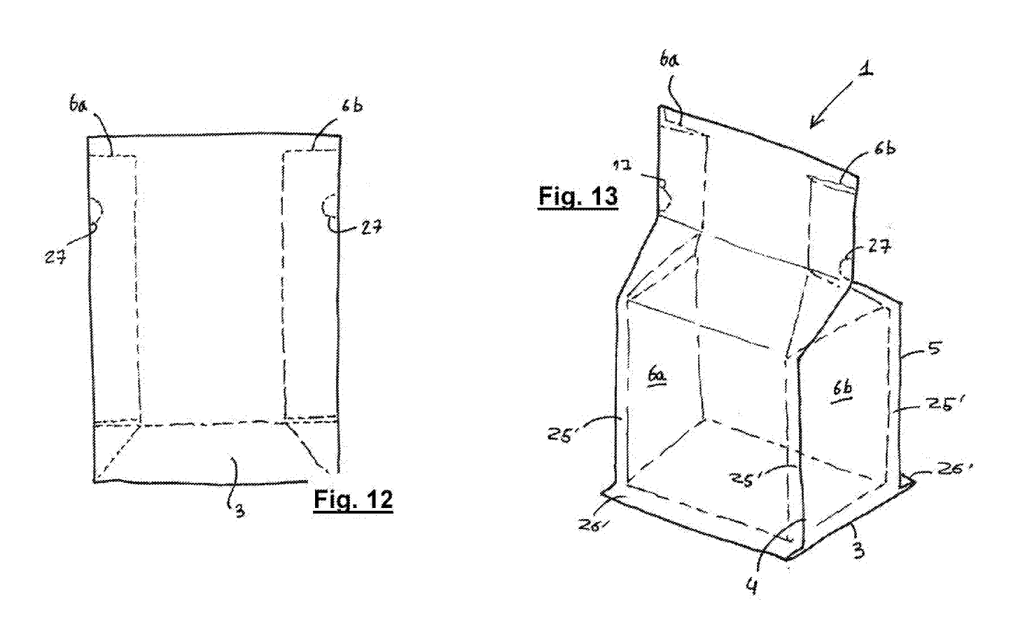

The effects produced on a finished container 1 by the welding bars 25 and 26 are schematically represented in the package 1 of FIGS. 13 and 15, with the references 25′ and 26′, respectively.

Once individualised the packages 1, their filling and closing can be performed on the same production line using means identical to those used in a conventional module for filling and closing “doy-pack” type packages. For example, the use of package transfer means of containers and a horizontal packaging machine as described in the patent document WO2014207278 is contemplated. Thus, in one single production line, packages 1 are made; and are filled and closed, for example, for delivery to a packing station.

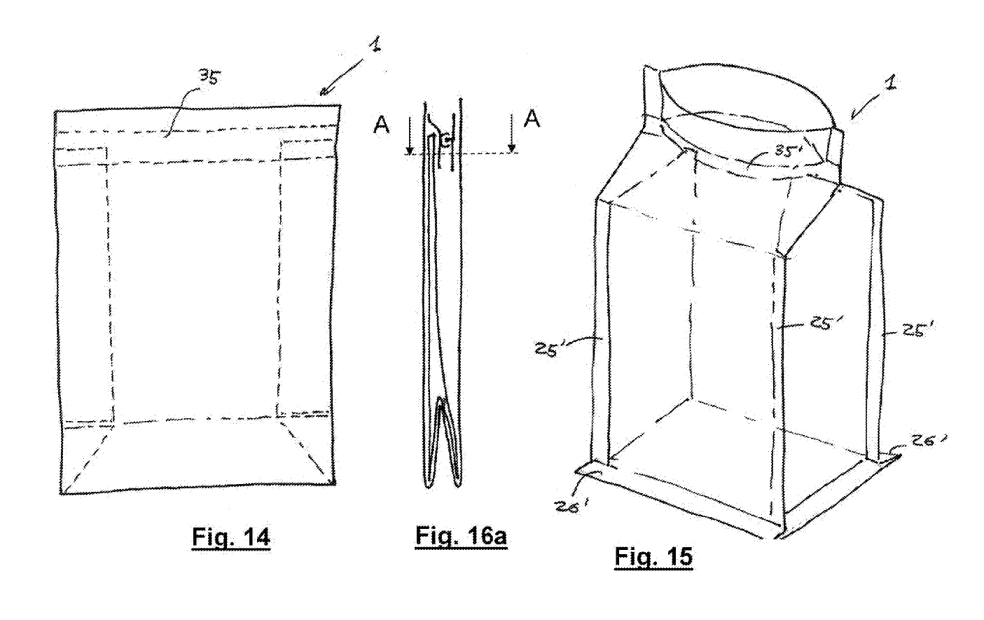

In the example of FIGS. 13 and 14, for directly bonding the side walls 4 and 5 of the container in the area near its upper mouth, the method contemplates that the sheets 66 have, in each bonding portion 20a, 20b, or adjacent thereto, pairs of slits or perforations 27 which are overlaid when the folded sheet 66 is inserted into the web 2, so that the transverse seal with the welding bars 25 make contact through said slits or perforations and the subsequent bonding together of the opposite walls 4′, 5′ of the web 2, i.e., the side walls 4, 5 of the container 1 once the transverse cut 16 is performed. The bonding of the side walls 4 and 5 gives the container 1 a flattened shape at its upper mouth, suitable to be held by its edges by means of respective clamps of the type that are used in its transportation and for the operations of opening, filling and closing.

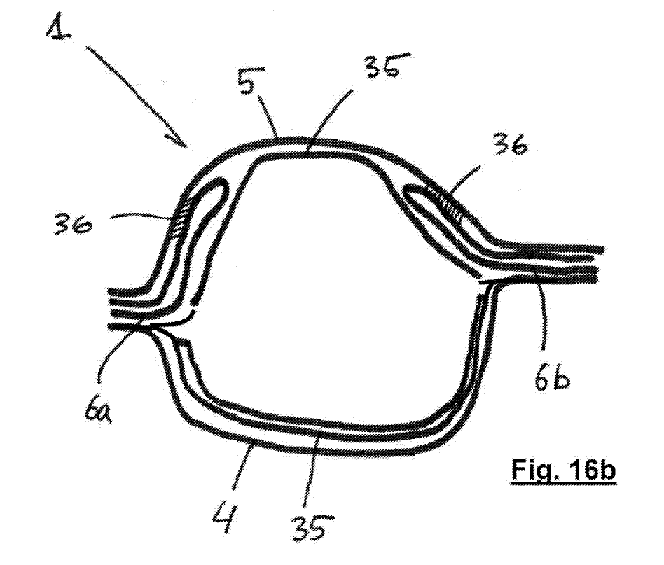

FIG. 16 schematically shows a detail of the container obtainable according to the invention and illustrated in FIGS. 14 and 15 from its upper opening, when said opening is forced into an open position. This container 1 is provided with a fitting for reversible closure, for instance in the form of a zip type closure 35, shown schematically in FIGS. 14 and 15.

In this case, it may be of interest that the two halves of the side wings 14a and 14b of the corresponding side walls 6a, 6b are juxtaposed and folded down on one side, bonded in areas 36 to a side wall 4 or 5 of the container 1, in order to ensure the water/air tightness thereof when the side walls 4 and 5 are juxtaposed and bonded together and no product residue that fills the container 1 remains in the spout formed by the outer face of said side walls 6a and 6b, folded towards the inside of the container 1 at its upper end.

Advantageously, the operations that are performed downstream of the preliminary bonding of the folded sheet 66 to the web 2 are compatible, that is, they can be performed using the same means that machines that manufacture “doy-pack” type containers have for this purpose. These machines are also generally provided with means for supplying a starting web and for folding it upon itself in order to obtain a W shape. Consequently, by equipping a machine of this type with a module 33 it is possible to manufacture “doy-pack” type containers or “quad-seal” type containers simply enabling or disabling the module 33, i.e., choosing if it is desired to introduce or not, between the opposite walls 4′, 5′ of the web 2, the folded sheets 66, whose bonding with the web form first dividing walls 6a′, 6b′ on the continuous web 2, which, subsequently, will become side faces 6a, 6b in made containers when proceeding to transversely cut the web 2 in coincidence with the folded sheets 66 as explained above.

1. A method for manufacturing flexible containers (1) of the type comprising a lower base (3) of essentially parallelogram configuration and four side faces (4, 5, 6a, 6b), the method comprising the operations of
supplying a continuous web (2) folded upon itself around longitudinal fold lines forming a W-shaped pleated area determining an inverted “V” shaped bottom (3′), a central fold (7) being distinguished, which remains arranged between two opposite walls (4′, 5′) of the web (2).
inserting folded sheets (66) into the web (2) between its opposite walls (4 ‘, 5’) so that, at least, one bonding portion (20a, 20b) in each folded sheet (66) is attached to the opposite walls (4′, 5′) and to the inverted “V” shaped bottom (3′) of the web (2), and
bonding said folded sheets (66) to the web (2) in said bonding portion or portions (20a, 20b) to determine dividing walls (6a′, 6b′) on the web (2) prior to performing transverse cuts (16) on the web (2) to individualise a container (1), the cuts (16) being distanced so that each container (1) includes, at least, two of said dividing walls (6a′, 6b′), which will form the two respective side walls (6a, 6b) in each container (1).

2. The method, according to claim 1, characterised in that the extension of the folded sheets (66) is suitable for making each one two side faces (6a, 6b) of two containers to be manufactured consecutively, each folded sheet (66) comprising two bonding portions (20a and 20b) whose bonds with the opposite walls (4′, 5′) and with the bottom (3′) determine a double dividing wall (6a′ and 6b′) on the web (2), and in that the method comprises performing transverse cuts (16) on the web (2) between the bonding portions (20a and 20b) of the same folded sheet (66), so that on each side of the transverse cut (16) a dividing wall (6a′, 6b′) will form one side wall (6a, 6b) of two consecutive containers.

3. The method, according to claim 2, characterised in that it comprises the operations of
supplying sheets (6) of suitable extension for making each one two side faces (6a, 6b) of two containers to be manufactured consecutively, each sheet (6) having, in a central area, a series of fold lines forming a rhombic FIG. 9), engraved on the sheet (6), so that the two opposite vertices (9a, 9b) end in respective edges (10, 11) of the sheet (6); and a straight fold line (12) with a central sector (12a) extending between the other two vertices (9c, 9d) of the rhombic FIG. 9) and two end sectors (12b, 12c) each extending from the central sector (12a) to a corresponding end of the sheet (6).
folding the sheet (6) in a direction around the end sectors (12b, 12 c) of the straight fold line (12) and folding, in an opposite direction, the sheet (6) around the central sector (12a) of said straight fold line, allowing that the sheet is also folded around the sides (99a; 99b; 99c; 99d) of the rhombic FIG. 9) to obtain a folded sheet (66), determining a flattened formation, in which a sort of triangular peak (13) is distinguished able to fold down around the central sector (12a) of the straight fold line (12), and two side wings (14a, 14b), which each will determine a dividing wall (6a′, 6b′) on the web (2);
arranging the thus folded sheet (66) between the opposite walls (4′, 5′) of the web (2), so that the central sector (12a) of the straight fold line (12) meets the centre fold (7) of the inverted “V” shaped bottom (3′) on the web (2), the edges (10, 11) of the folded sheet (66) and its straight imaginary extensions through the inside part of the spout (13) determining respective bonding portions (20a, 20b) of the folded sheet (66), which remain attached to the opposite walls (4′, 5′) and the bottom (3′) of the web (2); and
bonding the web (2) and the folded sheet (66) in said bonding portions (20a, 20b) to form the double dividing wall (6a′, 6b′) on the web (2).

4. The method, according to claim 3, characterised in that, prior to bonding the web (2) and the folded sheet (66) on said bonding portions (20a, 20b) to form the double dividing wall (6a′, 6b′) on the web (2), a preliminary operation of bonding the sheet (66) to the web (2) is performed, comprising bonding small areas (34) of each side wing (14a, 14b) to each one of the two opposite walls (4′, 5′) of the web (2).

5. The method, according to claim 3, characterised in that the sheets (6) are cut from a continuous auxiliary web (21) drawn from another storage web reel and, and in that fold lines according to the rhombic FIG. 9) and to the straight fold line (12) are marked on them prior to or after being cut from the auxiliary web (21).

6. The method according to claim 1, comprising performing
longitudinal bonding seams on the web (2) coinciding with the folding lines, which limit the “V” shaped bottom (3) with each of the opposite walls (4′, 5′) of the web (2) once the folded sheets (66) are inserted into the web (2).

7. The method according to claim 1, wherein the folded sheets (66) have, at each bonding portion (20a, 20b) or adjacent thereto, pairs of slits or perforations (27), which overlie when the folded sheet (66) is introduced into the web (2), the method comprising the operation of bonding together the opposite walls (4′, 5′) of the web (2) or the side walls (4′, 5′) of a container (1) through said slits or perforations (27).

8. The method for the manufacture of flexible containers (1) of the type comprising a lower base (3) and, at least, two opposite side faces (4, 5), comprising the operations of
supplying a continuous web (2) folded upon itself around longitudinal fold lines forming a W-shaped pleated area determining an inverted “V” shaped bottom (3′), a central fold (7) being distinguished, which remains arranged between two opposite walls (4′, 5′) of the web (2), intended to form respectively first and second opposite side faces (4, 5) of a container, the method being characterised in that it comprises choosing the type of container to be manufactured from at least two types
a first type in which the side faces (4, 5) of the container are bonded together by determining two side seams in the finished container, for which the method comprises the step of performing transverse seals on the web to bond the opposite walls (4′ and 5′) together of the web prior to cutting the web (2) transversely to individualise a container; or
a second type in which, between the side faces (4, 5) of the container, a third (6a) and a fourth (6b) side face are interposed on each side of the container, providing the container with the ability to take, on standing, an essentially quadrangular or square shape, for which the method comprises the step of inserting folded sheets (66) on the web (2) between its opposite walls (4′, 5′) so that at least one bonding portion (20a, 20b) on each folded sheet (66) is attached to the opposite walls (4′, 5′) and the inverted “V” shaped bottom (3′) of the web (2); and bonding these folded sheets (66) to the web (2) in said bonding portion or portions (20a, 20b) to determine dividing walls (6a′, 6b′) on the web (2) prior to transverse cutting (16) on the web (2) to individualise a container (1), the cuts (16) being distanced so that each container (1) includes, at least, two of said dividing walls (6a′, 6b′), that will form respective side walls (6a, 6b) in each container (1).

9. A module (33) for the manufacture of flexible containers (1), adapted to form dividing walls (6a′, 6b′) on a continuous web (2) folded upon itself around longitudinal fold lines forming a W-shaped pleated area that determines an inverted “V” shaped bottom (3′), a central fold (7) being distinguished, which remains arranged between two opposite walls (4′, 5′) of the web (2).
means prepared for supplying previously manipulated sheets (6) to mark preferred fold lines on them;
folding means and introducing means (28) acting in a coordinated manner to shape the sheet (6) by folding it around the preferential fold lines and accompanying the folded sheet (66) until arranging it within the web (2) and so that, at least, one bonding portion (20a, 20b) on the folded sheet (66) is attached to the opposite faces (4′, 5′) and to the inverted “V” shaped bottom (3′) of the web (2); and
means for bonding these sheets (66) to the web (2) on said bonding portions (20) for determining dividing walls (6a′, 6b′) on the web (2).

10. The module (33), according to claim 9, characterised in that the folding means and introducing means (28) comprise a pusher (22), movable toward the web (2) in a direction essentially normal to the extension thereof; and an introducing template (22′), generally funnel-shaped and intended to be traversed by the assembly formed by the pusher and the folded sheet (66) that accompanies said pusher (22) in its trajectory towards the web (2).

11. The module (33), according to claim 10, characterised in that the folding means and introducing means (28) comprise a series of ridges (31) formed on the pusher (22) acting on the sheet (6) during its pushing in combination with the passage section offered by the introducing template (22′), whose profile determines the gauge of the folded sheet on its passage through the introducing template (22′).

12. The module (33), according to claim 9, characterised in that it comprises stop means (24) for receiving the slidable support of the bottom (3′) of the web (2) and prepared to act as end of stroke of the folded sheet (66) with interposition of the bottom (3′) of said web (2).

13. The module (33), according to claim 12, characterised in that the stop means (24) are heated.

14. The module (33), according to claim 9, characterised in that it comprises means for pre-welding (23), prepared for provisionally bonding in small areas the sheets (66) to each of the opposite walls (4′, 5′) of the web (2).

15. A machine for the manufacture of flexible containers (1) of the type comprising a lower base (3) of essentially parallelogram configuration and four side faces (4, 5, 6a, 6b), the machine comprising
means for supplying a continuous web (2) folded upon itself around longitudinal fold lines forming a W-shaped pleated area determining an inverted “V” shaped bottom (3′), a central fold (7) being distinguished, which remains arranged between two opposite walls (4′, 5′) of the web (2); and
a module according to claim 9.

16. A flexible container (1) comprising a lower base (3) of essentially parallelogram configuration, from which, four sides faces rise (4, 5, 6a, 6b), the lower base (3) and two of its noncontiguous side faces (4, 5) being integrally formed by the same sheet; and the two remaining side faces (6a, 6b) by respective auxiliary sheets; wherein said remaining side faces are in a top part of the container (1) folded towards the interior thereof, the container being able to take on, in said top part, a flat shape by juxtaposing the side faces (4, 5); and in which, parts of the container have been included in this top part to prevent the unfolding of said side faces in the form of
bonds between parts of the sheet through the remaining side faces; and/or
bonds of each of the remaining side faces to the sheet on one of the side faces.
